(19) United States
(12) Patent Application Publication
(10) Pub. No.: US 2020/0055125 A1
(43) Pub. Date: Feb. 20, 2020

(54) CUTTING TOOL WITH PROTECTED JOINT

(71) Applicant: Star Cutter Company, Farmington Hills, MI (US)

(72) Inventor: Paul Schulte, Farmington Hills, MI (US)

(21) Appl. No.: 16/541,681

(22) Filed: Aug. 15, 2019

Related U.S. Application Data
(60) Provisional application No. 62/765,026, filed on Aug. 17, 2018.

(51) Int. Cl. B23B 51/00

(52) U.S. Cl. CPC B23B 51/00

(57) ABSTRACT

A cutting tool comprising: (a) a shank being configured to connect the cutting tool to machine; (b) a body connected to and extending from the shank, the body including: (i) a longitudinal axis; (ii) a plurality of flutes, (iii) one or more pockets located in one or more of the plurality of flutes; (iv) one or more shield substrates located in each of the one or more pockets; and (v) one or more joints connecting the one or more shield substrates to the one or more pockets, the one or more joints including a leading portion; (c) a tip connected to and extending from the body, the tip including a cutting surface that extends radially outward from the longitudinal axis a distance so that a clearance cut by the tip into a substrate is sufficiently large so that the leading portion of the one or more joints extends within the clearance.

### FIELD

The present teachings relate generally a cutting tool that includes one or more polycrystalline diamond cutting tips (PCD) joined to the cutting tool and more particularly a polycrystalline diamond cutting tip that is connected to a carbide drill with a brazed joint.

### BACKGROUND

Cutting tools are used for removing material, boring recesses, boring holes, forming a shape, or a combination thereof within a substrate. Cutting tools that may cut one material well, may not perform well with another material. Some cutting tools may expand an existing hole, while other tools may be better at creating a hole. Some applications may need a tool with a high level of precision in boring a hole so that fasteners inserted within the hole are held to tight tolerances. As cutting tools are used to cut harder and harder surfaces additional pieces are added to the cutting tools to prevent damage to a body of the cutting tool or a cutting surface of the cutting tool. Moreover, some materials of the substrate may damage the cutting tools as the cutting tools move relative to the substrate so that new cutting tools are frequently needed to maintain a tolerance for a cut shape within the substrate. In some instances, a carbide piece of polycrystalline diamond (PCD) may be located within the cutting tool to cut had materials. Examples of some cutting devices are disclosed in U.S. Pat. Nos. 4,944,640; 5,112,167; 5,297,456; 5,312,208; 6,929,434; 7,871,224; 8,342,780; 8,342,781; 8,882,412; 9,079,260; 9,321,111; 9,409,239; 9,694,432 and U.S. Patent Application Publication Nos. 2015/0283625 all of which are expressly incorporated herein by reference for all purposes.

What is needed is a cutting tool that bores holes with a high tolerance. What is needed is a cutting tool including one or more hardened materials connected to the cutting tool that cut hard substrates. It would be desirable to have a hardened material such as carbide, diamond, a PCD, or a combination thereof connected to a cutting tool by a joint. What is needed is a cutting tool that protects the joint, prevents the joint and substrate from coming into direct contact, chips of the substrate from directly contacting the joint, or a combination thereof. It would be desirable to have one or more cutting surfaces that create a clearance so that as all or a portion of a joint passes behind the one or more cutting surfaces, the portion of the joint is prevented from being in direct contact with the substrate.

### SUMMARY

The present teachings include: a cutting tool comprising: (a) a shank being configured to connect the cutting tool to machine; (b) a body connected to and extending from the shank, the body including: (i) a longitudinal axis; (ii) a plurality of flutes, (iii) one or more pockets located in one or more of the plurality of flutes; (iv) one or more shield substrates located in each of the one or more pockets; and (v) one or more joints connecting the one or more shield substrates to the one or more pockets, the one or more joints including a leading portion; (c) a tip connected to and extending from the body, the tip including a cutting surface that extends radially outward from the longitudinal axis a distance so that a clearance cut by the tip into a substrate is sufficiently large so that the leading portion of the one or more joints extends within the clearance.

The present teachings provide a cutting tool that bores holes with a high tolerance. The present teachings provide a cutting tool including one or more hardened materials connected to the cutting tool that cut hard substrates. The present teachings provide a hardened material such as carbide, diamond, a PCD, or a combination thereof connected to a cutting tool by a joint. The present teachings provide a cutting tool that protects the joint, prevents the joint and substrate from coming into direct contact, chips of the substrate from directly contacting the joint, or a combination thereof. The present teachings provide one or more cutting surfaces that create a clearance so that as all or a portion of a joint passes behind the one or more cutting surfaces, the portion of the joint is prevented from being in direct contact with the substrate.

### BRIEF DESCRIPTION OF THE DRAWINGS

FIG. 1 illustrates a perspective view of a cutting tool;

FIG. 2 illustrates a close-up perspective view of a cutting tool;

FIG. 3 illustrates a top view of a cutting tool;

FIG. 4 illustrates a close-up side view of a cutting tool;

FIG. 5 illustrates partial perspective view 5-5 of FIG. 2; and

FIG. 6 illustrates partial perspective view 6-6 of FIG. 2.

### DETAILED DESCRIPTION

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present device is a cutting tool. The cutting tool functions to remove material, shape material, form a hole, form a bore, form a recess, or a combination thereof. The cutting tool may be a reamer. Preferably, the cutting tool is a drill or drill bit that makes holes. The drill bit may be particularly suited for forming a portion of a substrate. The substrate may be made of steel, stainless steel, 308 steel, 316 steel, titanium, aluminum, cast iron, or a combination thereof. The cutting tool may be rotated to cut. The cutting tool may be rotated at 200 revolutions per minute (RPM) or more, about 300 RPM or more, or about 500 PRM or more. The cutting tool may be connected to a cutting device, a drill, a motor, or a combination thereof by one or more shanks.

The one or more shanks may function to fit within a connection device, a chuck, or both when the cutting tool is being used. The one or more shanks may be solid. The one or more shanks may include one or more coolant passages. The one or more shanks may be round, oval, square, made of the same material as a body, extend along a longitudinal axis, or a combination thereof. The one or more shanks and the body may be formed from the same material. The one or more shanks may be located proximal to a user, extend into a tool used for using the cutting tool, or a combination thereof. A body may be connected to and extend distal of the shank.

The body may function to extend distally from a tool, distally from a shank, remove material, begin cutting a hold, increase a size of a hole, finish a hole, or a combination thereof. The body may be sufficiently long to extend into and through a substrate to create a hole in the substrate. The one or more coolant passages may extend through the shank and into the body. The one or more coolant passages may extend through the body. The body may include all or a portion of the flutes, pockets, gashes, cutting surfaces, shields, or a combination thereof. The body may be located between a shank and a tip. The tip may extend axially outward from the body.

The one or more tips may function to begin a cut within a substrate, create a clearance within a substrate, create an intersection within a substrate, or a combination thereof. The one or more tips may assist in moving the cutting tool axially. The one or more tips may assist in moving the cutting tool axially and create a clearance so that as the resistant shield, shield substrate, or both are moved into contact with the substrate, a portion of the resistant shield, the shield substrate, a joint connecting the resistant shield, a joint connecting the shield substrate, or a combination thereof are prevented from directly contacting the substrate, are free of contact with the substrate, or a combination thereof. The one or more tips may have a length. A length of the tip may extend radially outward from a longitudinal axis of the cutting tool. The length of the tip radially outward may be sufficiently long so that a portion of the tip creates a clearance that a portion of the joint, resistant shield, shield substrate, or a combination thereof pass through. The tip may extend radially outward a distance so that the length of the tip is about 0.4 times or more, about 0.5 times or more, about 0.6 times or more, or about 0.7 times or more a length of the resistant shield, length of the shield substrate, length of a joint, or a combination thereof in the radial direction from the longitudinal axis. The tip may extend radially outward a distance so that the length of the tip is about 1.0 times or less, about 0.9 times or less, about 0.8 times or less, or about 0.75 times or less a length of the resistant shield, length of the shield substrate, length of a joint, or a combination thereof in the radial direction from the longitudinal axis. The tip may have a height in the axial direction. A height of the tip may be sufficiently long so that when the tip creates a clearance or an intersection a portion of a joint is free of contact with the joint, a resistant shield, a shield substrate, or a combination thereof. The tip may include one or more cutting surfaces. The one or more cutting surfaces may create a recess, a clearance, an intersection, or a combination thereof. The tip may include two cutting surfaces. The two cutting surfaces may have a portion that is located proximate to one another. The two cutting surfaces may be located proximate to each other at an intersection, the rotational axis, or both. The intersection of the two cutting surfaces may be at the rotational axis. The two or more cutting surfaces of tip may form an intersection within a substrate. Preferably, the substrate and the tip of the drill meet at the intersection where the drill begins to remove material from the substrate. The tip, the intersection, or both may only remove enough material to create a clearance that protects the leading portion, the joint, or both. The one or more cutting surfaces may include a primary cutting surface, a secondary cutting surface, or both. The primary cutting surface, the secondary cutting surfaces, or both of the tip may be formed within a wall proximate to or forming one side of a flute and preferably one wall of a removal flute.

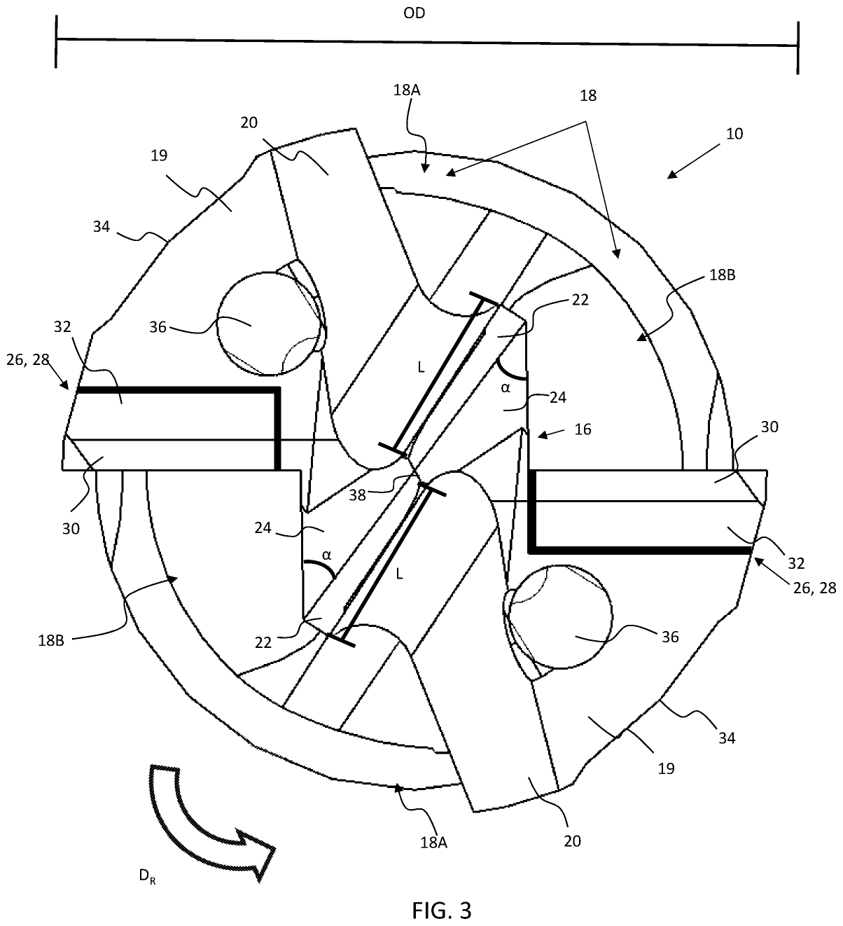

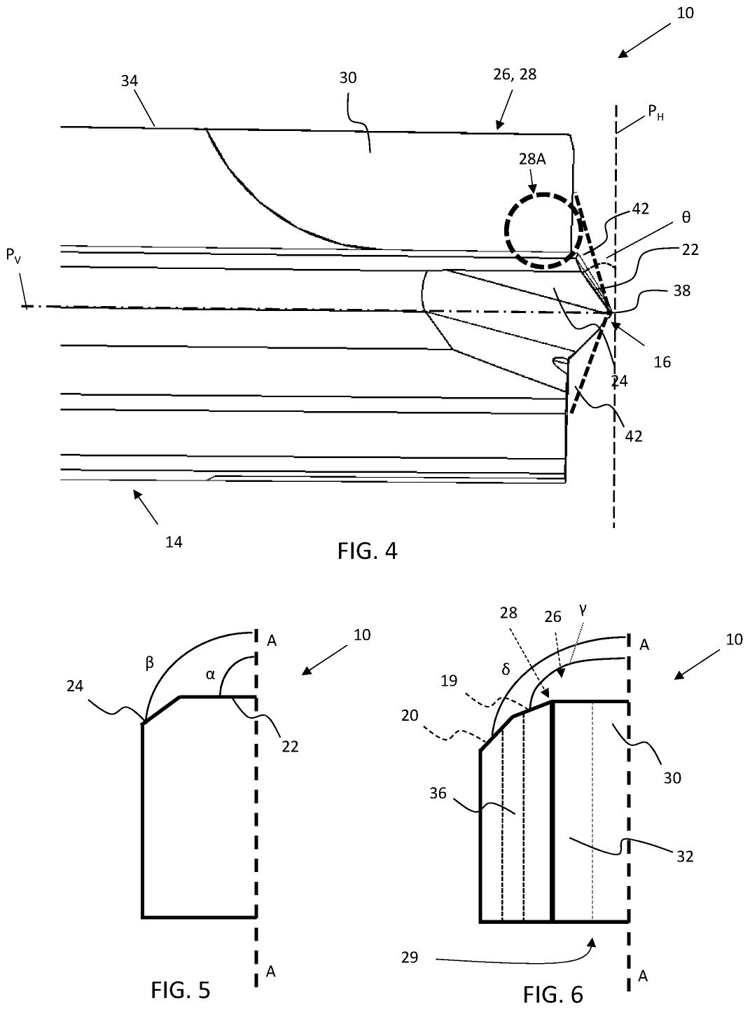

The primary cutting surface functions to remove material, form a hole, create a bore, or a combination thereof. The primary cutting surface may remove material after the tip creates an intersection, clearance, or both. The primary cutting surface includes a leading end and a cutting surface. The cutting surface contacts the substrate and assists in removing material, creating an intersection in the substrate, creating a clearance in the substrate, or a combination thereof. The leading end may have a portion that contacts the substrate and a portion that extends away from the substrate so that the leading end is free of contact with the substrate. The leading end form an angle with the longitudinal axis of the cutting tool, the cutting surface or both. The leading end of the primary cutting surface may extend at one or more angles and preferably two or more angles. The leading end may have a first angle that extends from the longitudinal axis towards an exterior radiused surface. Thus, the leading end may have a highest portion proximate to the longitudinal axis or a center of the cutting tool and then angle downward towards the exterior radiused surface. The angle from the center or longitudinal axis (or rotational axis) towards the exterior radiused surface may be about 5 degrees or more, about 10 degrees or more, about 15 degrees or more, or about 20 degrees or more relative to a plane (e.g., a horizontal plane) that is perpendicular to a plane extending through the longitudinal axis, the rotational axis, or both (See e.g., 6 in FIG. 4). For example, the cutting tool includes a vertical plane extending along a diameter of the cutting tool that extends through the longitudinal axis, the rotational axis, or both and a horizontal plane extends perpendicular to the vertical plane and the primary cutting surface extends towards the exterior radiused surface at an angle relative to the horizontal plane. The angle from the center or longitudinal axis (or rotational axis) towards the exterior radiused surface may be about 75 degrees or less, about 60 degrees or less, about 45 degrees or less, or about 25 degrees or less relative to a plane (e.g., a horizontal plane) that is perpendicular to a plane extending through the longitudinal axis, the rotational axis, or both. The primary cutting surface may have a leading end that extends at an angle relative to a face or a cutting surface of the primary cutting surface. The face or cutting surface may extend parallel to the longitudinal axis or a plane that includes the longitudinal axis. The leading end may extend at an angle of about 95 degrees or more, about 100 degrees or more, about 105 degrees or more, or about 110 degrees or more (see e.g., a of FIG. 5). The leading end may extend at an angle of about 135 degrees or less, about 125 degrees or less, or about 115 degrees or less. The primary cutting surface may have a length. The length of the primary cutting surface may be sufficiently long so that a clearance cut by the primary cutting surface is free of contact with all or a portion of a joint. The length of the primary cutting surface may be sufficiently long so that a leading portion of a joint is free of contact with the substrate. The primary cutting surface may extend a distance from the rotational axis towards the exterior radiused surface so that the material removed from the substrate is free of contact with a joint or a leading portion of a joint. The primary cutting surface may extend a distance that is 50 percent or more, 60 percent or more, or about 70 percent or more of a length between the rotational axis and the exterior radiused surface, a length of the joint, or both. The primary cutting surface may extend a distance that is 100 percent or less, 90 percent or less, or about 80 percent or less of a length between the rotational axis and the exterior radiused surface, a length of the joint, or both. The primary cutting surface may be the only surface of the tip that cuts and removes material from the substrate. The primary cutting surface may cut material from the substrate and the secondary cutting surface may assist in removing material.

The secondary cutting surface may function to move material that is removed by the primary cutting surface, guide material into a flute, or both. The secondary cutting surface may create a clearance between the substrate and the tip so that removed material can move as more material is being cut or removed. The secondary cutting surface may extend at an angle relative to the primary cutting surface, a vertical plane, the longitudinal axis, or a combination thereof. The secondary cutting surface may extend away from the longitudinal axis at an angle that is larger than the primary cutting surface. The secondary cutting surface may extend at an angle that is about 1 degree or more, about 3 degrees or more, about 5 degrees or more, or about 15 degrees or less than a primary cutting surface relative to the longitudinal axis. The secondary cutting surface may extend from a horizontal plane at substantially a same angle as the primary cutting surface. The secondary cutting surface may extend at an angle that is about 1 degree or more, about 3 degrees or more about 5 degrees or more, or about 10 degrees or less than the primary cutting surface extends from a horizontal plane. The tip, the primary cutting surface, secondary cutting surface, cutting members, joints, flutes, pockets, or a combination there may have a terminal end that is located at a leading end of the cutting tool.

The terminal end functions to be an end of the cutting tool that contacts the substrate first. The terminal end is the cutting end of the cutting tool, the end that contacts the substrate first, or both. The terminal end may be the end with the cutting faces. The terminal end may include a primary cutting surface, secondary cutting surface, pocket, joint, leading joint portion, resistant shield, shield substrate, flute, or a combination thereof.

The one or more flutes function to allow material to move from a terminal end or a cutting surface away from the substrate. The one or more flutes function to remove material from a hole, bore, hole, opening, or a combination thereof during a cutting operation. The one or more flutes may be an absence of material in the cutting tool. The one or more flutes may be “v” shaped, have an arcuate surface, have one or more flat faces, be located between two or more opposing walls, or a combination thereof. One or more flutes may be an absence of material that exposes one or more faces or cutting surfaces of the cutting tool. The one or more flutes may include a removal flute, a pocket flute, or both.

The one or more removal flute may function to remove material from a substrate as the cutting tool cuts material. The removal flute may be located between the primary cutting surface and a gash or a rear surface of a cutting member. The removal flutes may expose a primary cutting surface so that as the cutting tool rotates the primary cutting surface contacts the substrate. The removal flute may helically wrap around the tip, body, or both of the cutting tool. Preferably, the removal flute extends parallel to the longitudinal axis, in a straight line, or both. More preferably, each cutting tool includes two removal flutes. The cutting tool may include more than one removal flute. The removal flutes may be located on opposing sides of the cutting tool. The removal flutes may be located diagonally opposite each other. The removal flutes and pocket flutes may be alternating when extending along an exterior radiused surface of the cutting tool.

The one or more pocket flutes may function to expose a face or cutting surface of a cutting member, remove material, or both. The one or more pocket flutes may be located between a secondary cutting surface and a cutting member, a pocket, a resistant shield, or a combination thereof. The one or more pocket flutes may be an absence of material. The pocket flutes may expose a face or cutting surface of the cutting member so that as the cutting member rotates the cutting member contacts the substrate and removes material from the substrate. The pocket flutes may helically wrap around the tip, body, or both, of the cutting tool. Preferably, the pocket flutes extend parallel to the longitudinal axis, in a straight line, or both. More preferably, each cutting tool includes two pocket flutes. The cutting tool may include more than one pocket flute. The pocket flutes may be located on opposing sides of the cutting tool. The pocket flutes may be located diagonally opposite each other. The removal flutes and pocket flutes may be alternating when extending along an exterior radiused surface of the cutting tool. A wall may be located between each of the removal flutes and the pocket walls. A wall including the tip, primary cutting surface, secondary cutting surface, or a combination thereof may be located between the removal flute and the pocket flute. A wall including a pocket, cutting member, shield clearance, gash, or a combination thereof may be located between the removal flute and the pocket flute.

The one or more shield clearances may function to support a joint, cutting member, or both and prevent material from damaging the joint, cutting member, or both. The one or more shield clearances may create an open space or clearance behind a cutting member, a joint, or both. The cutting tool may have a plurality of shield clearances. The cutting tool may have one shield clearance on some of the walls. The shield clearance functions to include one or more coolant passages and permit fluid to be introduced into a region around a tip, terminal end, or both of the cutting tool. The shield clearance may be a tapering of material downward away from a horizontal plane so that a space is formed between the substrate and the terminal end. The shield clearance may extend at an angle of about 95 degrees or more, about 100 degrees or more, about 105 degrees or more, about 110 degrees or more, or about 115 degrees or more relative to a face, a cutting surface, a longitudinal axis, or a combination thereof of the cutting tool, the cutting member, or both. The shield clearance may extend at an angle of about 150 degrees or less, about 140 degrees or less, about 135 degrees or less, about 130 degrees or less, or about 125 degrees or less relative to a face, a cutting surface, a longitudinal axis, or a combination thereof of the cutting tool, the cutting member, or both. The shield clearance may extend at a first angle and then a gash may extend from the shield clearance at a second angle.

The one or more gashes may function to move fluid, material, or both into a flute, away from a cutting surface, face, or both. The one or more gashes may create a clearance, open space, or both. The one or more gashes may assist material in being removed from a hole or opening. The one or more gashes may include all or a portion of a coolant passage that introduces fluid at a terminal end of the cutting tool. The cutting tool may include a plurality of gashes. Some of the walls of the cutting tool may include a single gash. Each gash may extend at an angle relative to the shield clearance, a face, a cutting surface, a longitudinal axis, or a combination thereof. Each gash may extend at an angle relative to a shield clearance of about 1 degree or more, about 3 degrees or more, about 5 degrees or more, about 7 degrees or more, about 30 degrees or less, about 25 degrees or less, or about 20 degrees or less. The gash may extend at an angle of about 125 degrees or more, about 135 degrees or more, about 150 degrees or more, about 155 degrees or more, or about 160 degrees or more relative to a face, a cutting surface, a longitudinal axis, or a combination thereof of the cutting tool, the cutting member, or both. The shield clearance may extend at an angle of about 175 degrees or less, about 170 degrees or less, or about 165 degrees or less relative to a face, a cutting surface, a longitudinal axis, or a combination thereof of the cutting tool, the cutting member, or both. The one or more gashes may be located on an opposite side of a wall as a pocket.

The one or more pockets function to receive a cutting member. The one or more pockets hold a cutting member within a wall of the cutting tool. The one or more pockets may be square, rectangular, include an arcuate section, include planar sections, or a combination thereof. Each wall may include one pocket. Some walls may include a pocket. Some walls may be free of a pocket. Preferably, two walls include a pocket. The pocket may be an absence of material. The pockets may be an absence of material where a joint may hold a cutting member within the cutting tool.

The one or more joints function to connect a cutting member to a wall, a cutting tool, a pocket, or a combination thereof. The one or more joints may bond the cutting member to the body so that the cutting member cuts a substrate. The one or more joints may be a weld, solder, adhesive, chemical attachment, mechanical attachment, braze, or a combination thereof. Preferably, the joint is formed by brazing the cutting member within a pocket. The joint may have a leading portion and a trailing portion. The leading portion may be located proximate to the rotational axis of the cutting tool. The leading portion may be in a corner of the pocket where a width and a height of the cutting member are connected to the pocket by the joint. The leading portion may only be a height or a width of a joint. Preferably, the leading portion has a portion along a width and a portion along a length of the cutting member, the pocket, or both. The leading portion of the joint may fit within a clearance created by the tip, primary cutting surface, of both.

The clearance may function to create a gap between the substrate and the leading portion of the joint, the joint, or both. The clearance may be an absence of material where a portion of the joint, cutting member, or both pass without contacting the substrate. The clearance may extend at an angle. The angle may be sufficiently large so that the leading portion of the joint is free of contact with the substrate. The clearance may have a length that is greater than the length of all or a portion of the leading portion so that all of a portion of the leading portion is free of contact with the substrate. The clearance may be shorter than a length of the cutting member or a length of a wall including the cutting member when measured from the rotational axis to the external wall of the cutting member. The clearance may remove material so that a portion of the cutting member proximate to the leading portion of the joint is free of contact with the substrate.

The cutting member functions to remove material of the substrate, create a hole, or both. The cutting member may be a primary member that removes material from a substrate. For example, the tip may remove material to create a clearance or intersection but the tip may not remove material to create the hole, whereas the cutting member removes material to form the hole. The cutting member may remove material and finish the walls of the substrate within a hole formed by the cutting member. The cutting member may be an additional piece that may be connected to the cutting tool. The cutting member may be made of one or more pieces of material. Preferably, the cutting member is made of two or more pieces of material. The cutting member may be made of a material that is harder than the body of the cutting member, the substrate, or both. The cutting member may have a face, a cutting surface, or both that is parallel to the axis of rotation, parallel a longitudinal axis, parallel to a vertical plane, normal to a plane of the substrate, or a combination thereof. The cutting member may be made of one or more pieces of material. Preferably, the cutting member is made of two or more pieces of material. The cutting member may be made of a material that is harder than the body of the cutting member, the substrate, or both. The cutting member may include a resistant shield and a shield substrate.

The resistant shield functions to remove material from the substrate, bore a hole, cut the substrate, or a combination thereof. The resistant shield does a majority of the material removal created by the cutting tool (e.g., 80 percent or more, 90 percent or more, or even 95 percent or more). The resistant shield may remove all of the material except for the material removed in forming an intersection, clearance, or both. The resistant shield may have a portion that is protected within the clearance so that a portion of the resistant shield is free of contact with the substrate. The resistant shield may be made of or include carbide, diamond, a diamond like substance, a diamond like carbon, a diamond like coating, a graphene coating, wurtzite boron nitride, lonsdaleite, dyneema, metallic glass, buckypaper, or a combination thereof. Preferably, the resistant shield includes a diamond face or cutting surface. The diamond may be a real diamond, synthetic diamond, man-made diamond, or a combination thereof. The diamond may be polycrystalline diamond (PCD). The resistant shield may be connected to a shield substrate, the pocket, or both.

The shield substrate may function to reduce an amount of resistant shield needed, assist in connecting the resistant shield to the body, assist in connecting the resistant shield within a pocket, or a combination thereof. The shield substrate may be made of carbide, a metallic carbide, tungsten carbide, or a combination thereof. The shield substrate may be located between a joint and the resistant shield. The shield substrate and the resistant shield may be substantially the same width and length. The thickness of the shield substrate may be greater than the thickness of the resistant substrate or vice versa. The shield substrate, the resistant substrate, or both may extend from a location proximate to the longitudinal axis to a location proximate to the exterior radiused surface or to the exterior radiused surface.

The exterior radiused surface may be an outer surface of the body, shank, or both that is substantially a same size as the hole formed. The exterior radiused surface and an exterior edge of the cutting member may be a same location. The exterior radiused surface may form a portion of a perimeter of the cutting tool. The one or more coolant passages may be located within the exterior radiused surfaces.

The one or more coolant passages function to move a fluid from an external location of a cutting tool to a location proximate to the terminal end. The one or more coolant passages may begin at an end of shank. The one or more coolant passages may end in the body, the tip, or both. The one or more coolant passages may end in a shield clearance, a gash, or both. The one or more coolant passages may have a cross section that is a geometric shape, oval, circular, or a combination thereof. Preferably, the coolant passages are circular. An and of the coolant passages at the terminal end may have only a cross-section exposed. Preferably, a length of the coolant passage is exposed so that an increased area releases fluid relative to a cross-sectional area.

A flange may be located between the body and shank. The body may reduce in cross-sectional thickness relative to a shank at the flange. The flange may indicate an end of the shank, a beginning of a body, or both.

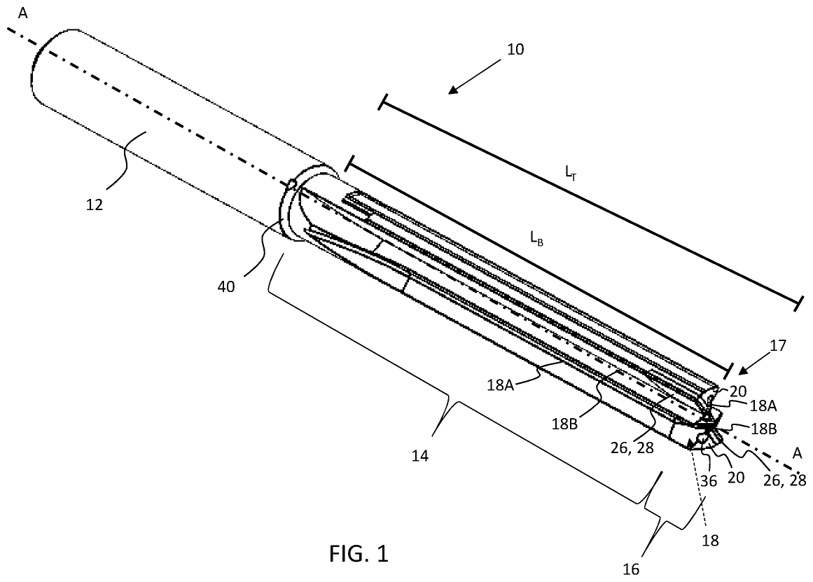

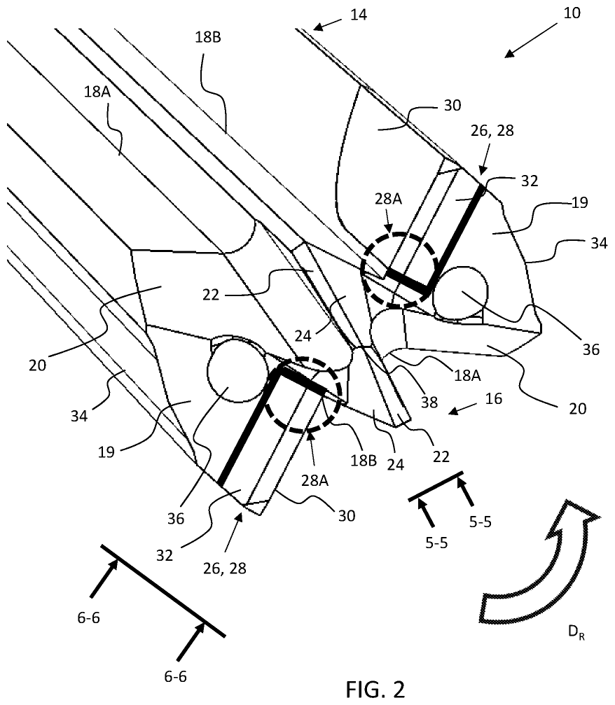

Turning now to the figures, FIG. 1 illustrates a perspective view of a cutting tool 10. The cutting tool 10 includes a shank 12. A body 14 of the cutting tool 10 extends from a flange 40 of the shank 12. The body 14 includes a plurality of flutes 18 extending along a longitudinal axis (A) of the cutting tool 10. The plurality of flutes 18 include removal flutes 18A and pocket flutes 18B configured to move material pieces axially along the cutting tool 10 during a cutting operation. The pocket flutes 18B each include a pocket 26 that houses a resistant shield secured to the pocket flutes 18B via a brazed joint 28 (see FIGS. 2 and 3). A plurality of coolant passages 36 extend axially from gashes 20 located near a terminal end 17 of the plurality of flutes 18 through the shank 12 of the cutting tool 10. A tip 16 extends from the body 14 and is configured to make initial contact with a surface during the cutting operation and create a clearance to begin cutting a substrate (not shown) and to prevent material contact with a portion of the joints 28 (see FIG. 4). It should be noted that a length from the flange 40 to an end of the tip 16 (LT) is greater than a length from the flange 40 to an end of the body (LB) so that the tip 16 may initially cut the material surface and create clearance for the portion of the joint 28.

FIG. 2 illustrates a close-up perspective view of a cutting tool 10. The cutting tool 10 includes a body 14. The body 14 includes a plurality of flutes 18 extending along a longitudinal axis of the cutting tool 10. The plurality of flutes include removal flutes 18A and pocket flutes 18B configured to move material pieces axially along the cutting tool 10 during a cutting operation. The pocket flutes 18B are a void between two walls and one wall of each pocket flute 18B includes a pocket 26 that houses a resistant shield 30 secured to the pocket 26 within the pocket flutes 18B via a joint 28. The resistant shields 30 are secured to a wall of the pocket flutes 18B via a shield substrate 32. A plurality of coolant passages 36 extend axially partially from a shield clearance 19 and partially from a gash 20 located near a terminal end 17 of the plurality of flutes 18 through the shank 12 of the cutting tool 10 at an opposing terminal end of the cutting tool 10. The shield clearance 19 extends at a first angle away from the pocket 26 and the gash 20 extends at a second angle away from both the pocket 26 and shield clearance 19. A tip 16 extends from the body 14 and is configured to make initial contact with a surface during the cutting operation and create a clearance to prevent material contact with a leading portion of the joints 28A (see FIG. 4). The tip 16 includes a pair of primary cutting surfaces 22 abutting a pair of secondary cutting surfaces 24 at an intersection 38. During the cutting operation, the primary cutting surfaces 22 and the secondary cutting surfaces 24 rotate in a direction (DR) to initially engage and cut the surface, thereby creating the clearance and preventing material contact with the leading portion 28A of the joint 28. As the cutting tool 10 continues to cut through the surface, a plurality of exterior radiused surfaces 34 extend through a circular hole in the surface (not shown) formed by the resistant shield 30.

FIG. 3 illustrates a top view of a cutting tool 10. The cutting tool 10 includes a plurality of flutes 18 extending along a longitudinal axis of the cutting tool 10 (see FIG. 1). The plurality of flutes 18 include removal flutes 18A and pocket flutes 18B, which are a void that is configured to move material pieces axially along the cutting tool 10 during a cutting operation. The pocket flutes 18B each include a wall with a pocket 26 that houses a resistant shield 30 and shield substrate 21 secured to the wall of the pocket flutes 18B via a joint 28. The resistant shields 30 are secured to a wall of the pocket flutes 18B via a shield substrate 32 and the joint 28. A plurality of coolant passages 36 extend axially partially from shield clearances 19 and partially from gashes 20 located near a terminal end of a wall of the plurality of flutes 18 through the cutting tool 10. A tip 16 of the cutting tool 10 is configured to make initial contact with a surface during the cutting operation and create a clearance to prevent material contact with a leading portion of the joints 28 (see FIG. 4). The tip 16 includes a pair of primary cutting surfaces 22 having a length (L) abutting a pair of secondary cutting surfaces 24 at an intersection 38. The secondary cutting surfaces 24 form an angle (a) with a surface of the primary cutting surfaces 22. During the cutting operation, the primary cutting surfaces 22 and the secondary cutting surfaces 24 rotate in a direction (DR) to initially engage and cut the surface, thereby creating the clearance and preventing material contact with the leading portion of the joint 28. As the cutting tool 10 continues to cut through the surface, a plurality of exterior radiused surfaces 34 form a circular hole in the surface having a diameter substantially similar to an outer diameter (OD) of the cutting tool 10.

FIG. 4 illustrates a close-up side view of a cutting tool 10. The cutting tool 10 includes a body 14 having a plurality of pockets 26 the house resistant shields 30 secured to the pockets 26 via joints 28. A tip 16 of the cutting tool 10 extends axially away from the body (not shown) and is configured to make initial contact with a surface during the cutting operation and create a clearance 42 to prevent material contact with a leading portion of the joint 28A. The tip 16 includes a pair of primary cutting surfaces 22 abutting a pair of secondary cutting surfaces 24 at an intersection 38. A vertical plane V_{P} extends through the cutting tool 10 along the longitudinal axis and a horizontal plane H_{P} extends perpendicular to the vertical plane V_{P}. The primary cutting surface 22 extends at an angle θ away from the horizontal plane H_{P} as the primary cutting surface 22 extends towards the exterior radiused surface 34.

FIG. 5 illustrates partial plan view 5-5 of the cutting tool 10 of FIG. 2. The cutting tool 10 includes a pair of primary cutting surfaces 22 abutting a pair of secondary cutting surfaces 24 (a single primary cutting surface 22 and a single secondary cutting surface 24 are shown). As illustrated, the primary cutting surface 22 forms an angle (a) with a longitudinal axis (A) of the cutting tool 10 and the secondary cutting surface 24 forms an angle (β) with the longitudinal axis (A) of the cutting tool 10. The longitudinal axis as shown extends parallel to the face of the primary cutting surface. It should be noted that the angle (a) between the primary cutting surface 22 and the longitudinal axis (A) may be less than the angle (β) between the secondary cutting surface 24 and the longitudinal axis (A).

FIG. 6 illustrates partial plan view 6-6 of the cutting tool 10 of FIG. 2. The cutting tool 10 includes pockets 26 that house a cutting member 29 including a resistant shield 30 and a shield substrate 32, with the cutting member 29 being secured to the pockets 26 via a joint 28. Coolant passages 36 extend axially through shield clearances 19 and gashes 20 located near a terminal end 17 of the cutting tool and terminate at an opposing terminal end of the shank of the cutting tool 10. As illustrated, a surface of the shield clearance 19 forms an angle (γ) with a longitudinal axis (A) of the cutting tool 10 and a surface of the gash 20 forms an angle (δ) with the longitudinal axis (A) of the cutting tool 10. The longitudinal axis as shown extends parallel to a face of the cutting member 29. It should be noted that the angle (γ) between the shield clearance 19 and the longitudinal axis (A) may be less than the angle (δ) between the gash 20 and the longitudinal axis (A).

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of or consist of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the teaching should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

### ELEMENT LIST

10 Cutting Tool
12 Shank
14 Body
16 Tip
17 Terminal End
18 Flute
18A Removal Flute
18B Pocket Flute
19 Shield Clearance
20 Gash
22 Primary Cutting Surface
24 Secondary Cutting Surface
26 Pocket
28 Joint
28A Leading Portion (Joint)
29 Cutting Member
30 Resistant Shield
32 Shield Substrate
34 Exterior Radiused Surface
36 Coolant Passage
38 Intersection
40 Flange
42 Clearance
A Longitudinal Axis (of the Cutting Tool)
D_{R} Direction of Rotation (of the Cutting Tool)
L Length of the Primary Cutting Surface
α Angle
β Angle
γ Angle
δ Angle
θ Angle
OD Outer Diameter (of the Cutting Tool)
H_{T} Height of the Tip
H_{B} Height of the Body
P_{V} Vertical Plane
P_{H} Horizontal Plane

I claim:

1) A cutting tool comprising:
a. a shank being configured to connect the cutting tool to machine;
b. a body connected to and extending from the shank, the body including:
i. a longitudinal axis;
ii. a plurality of flutes,
iii. one or more pockets located in one or more of the plurality of flutes;
iv. one or more shield substrates located in each of the one or more pockets; and
v. one or more joints connecting the one or more shield substrates to the one or more pockets, the one or more joints including a leading portion;
c. a tip connected to and extending from the body, the tip including a cutting surface that extends radially outward from the longitudinal axis a distance so that a clearance cut by the tip into a substrate is sufficiently large so that the leading portion of the one or more joints extends within the clearance.

2) The cutting tool of claim 1, wherein the leading portion of the one or more joints are free of contact with the substrate.

3) The cutting tool of claim 1, wherein the leading portion of the one or more joints is located within the one or more pockets at an end of the one or more pockets located proximate to the longitudinal axis.

4) The cutting tool of claim 1, wherein the tip includes a primary cutting surface and a secondary cutting surface.

5) The cutting tool of claim 4, wherein the primary cutting surface and the secondary cutting surface have a length that extends radially outward from the longitudinal axis.

6) The cutting tool of claim 5, wherein the length is less than a length of the one or more shield substrates.

7) The cutting tool of claim 1, wherein the plurality of flutes include one or more removal flutes and one or more pocket flutes.

8) The cutting tool of claim 1, wherein the one or more pockets and the one or more shield substrates are located the one or more pocket flutes.

9) The cutting tool of claim 7, wherein the one or more removal flutes are free of the one or more pockets, the one or more joints, the one or more shield substrates, or a combination thereof.

10) The cutting tool of claim 1, wherein the one or more shield substrates are connected to one or more resistant substrates.

11) The cutting tool of claim 10, wherein one or more resistant substrates are connected to the joint on one surface and the one or more shield substrates on an opposing surface.

12) The cutting tool of claim 1, wherein the tip includes a cutting surface extending in a first direction from the longitudinal axis and a second cutting surface extending in a second direction from the longitudinal axis.

13) The cutting tool of claim 12, wherein the cutting surface and the second cutting surface are located proximate to each other at an intersection that is located proximate to the longitudinal axis.

14) The cutting tool of claim 7, wherein the one or more removal flutes include a gash that extends from the one or more shield substrates towards the one or more removal flutes.

15) The cutting tool of claim 14, wherein the one or more removal flutes are an absence of material.

16) The cutting tool of claim 1, wherein the shank and the body include one or more coolant passages.

17) The cutting tool of claim 14, wherein one or more coolant passages extend through the gash in each of the one or more removal flutes.

18) The cutting tool of claim 3, wherein the leading portion of the one or more joints are free of contact with the substrate.

19) The cutting tool of claim 18, wherein the tip includes a primary cutting surface and a secondary cutting surface and the primary cutting surface and the secondary cutting surface have a length that extends radially outward from the longitudinal axis, and the length is less than a length of the one or more shield substrates.

20) The cutting tool of claim 14, wherein the one or more pockets and the one or more shield substrates are located the one or more pocket flutes.
